(19) United States
(12) Patent Application Publication
(10) Pub. No.: US 2013/0058483 A1
(43) Pub. Date: Mar. 7, 2013

(54) Public key cryptosystem and technique

(71) Applicants: William J. Whyte, Belmont, MA (US); Jeffrey Hoffstein, Providence, RI (US)

(72) Inventors: William J. Whyte, Belmont, MA (US); Jeffrey Hoffstein, Providence, RI (US)

(21) Appl. No.: 13/507,970

(22) Filed: Aug. 9, 2012

Related U.S. Application Data
(60) Provisional application No. 61/574,972, filed on Aug. 12, 2011.

(51) Int. Cl. H04L 9/30

(52) U.S. Cl. 380/255

(57) ABSTRACT

A method is set forth for encrypting and decrypting a message, including: selecting a plurality of integers and a plurality of vectors, and deriving therefrom a public key that includes a collection of vectors and a private key; selecting a message, in the form of a vector; selecting a vector of random weights; deriving a preliminary encrypted message, in the form of a vector, as a function of the selected message, the public key, and the random weights; evaluating the preliminary encrypted message to derive a normalizing value; combining the preliminary encrypted message and the normalizing value, to obtain a security-enhanced encrypted message; and decrypting the security-enhanced encrypted message using the private key, to recover the selected message.

### RELATED APPLICATION

This application claims priority from U.S. Provisional Patent Application No. 61/574,972, filed Aug. 12, 2011, and said Provisional Patent Application is incorporated herein by reference.

### FIELD OF THE INVENTION

This invention relates to encoding and decoding of information and, more particularly, to a public key cryptosystem for encryption and decryption of digital messages by processor systems.

### BACKGROUND OF THE INVENTION

Secure exchange of data between plural parties, for example between computers or mobile devices, requires encryption.

A public key cryptosystem is one in which each party can publish their encoding process without compromising the security of the decoding process. The encoding process is popularly called a trap-door function. Public key cryptosystems are in widespread use for transmitting important data and information, such as credit card numbers, and also to transmit a private key which is then used for private key encoding.

In the U.S. Pat. Nos. 6,081,597 and 6,298,137, assigned to the same ownership entity as the present Application, and incorporated herein by reference, there is disclosed a public key cryptosystem, which is a basis for a commercialized cryptosystem called “NTRU-Encrypt,” for which keys are relatively short and easily created, and for which the encoding and decoding processes can be performed rapidly. The technique thereof also has relatively low memory requirements and depends on a variety of parameters that permit substantial flexibility in balancing security level, key length, encoding and decoding speed, memory requirements, and bandwidth.

The technique of the referenced “NTRU-Encrypt” system allows keys to be chosen essentially at random from a large set of vectors, with key lengths comparable to the key lengths in other common public key cryptosystems, and provides encoding and decoding processes which are between one and two orders of magnitude faster than the most widely used public key cryptosystem. The encoding technique uses a mixing system based on polynomial algebra and reduction modulo two numbers, p and q, while the decoding technique uses an unmixing system whose validity depends on elementary probability theory. The security of the cryptosystem comes from the interaction of the polynomial mixing system with the independence of reduction modulo p and q. Security also relies on the experimentally observed fact that for most lattices, it is very difficult to find the shortest vector if there are a large number of vectors which are only moderately longer than the shortest vector.

As disclosed in the referenced U.S. Pat. Nos. 6,081,597 and 6,298,137, a method for encoding and decoding a digital message m, includes the following steps: selecting ideals p and q of a ring R; generating elements f and g of the ring R, and generating element F_{q} which is an inverse of f (mod q), and generating element Fₚ which is an inverse off (mod p); producing a public key that includes h, where h is congruent, mod q, to a product that can be derived using g and F_{q}; producing a private key from which f and Fₚ can be derived; producing an encoded message e by encoding the message m using the public key and a random element φ; and producing a decoded message by decoding the encoded message e using the private key.

As disclosed in an embodiment set forth in the above referenced U.S. Patents, an encrypted message e is in the form e=h·r+m (mod q), where h is the public key, r is a random element (described in an embodiment in the referenced Patents as the product pφ, where p is an originally chosen integer parameter which is part of the public key, and φ is a random polynomial) m is the digital message (e.g. in the form of a polynomial), and q is another originally chosen integer parameter (relatively prime with p) which is also part of the public key.

In a form of “NTRU Encrypt”, r includes r₁, r₂, r₃. Parameter sets specify the exact number of 1's and −1's in each of r₁, r₂, r₃, which reveals the quantity r(1). As an encrypted message has the form e=h·r+m, the value m(1) modulo q is implicitly revealed by the known quantities r(1), e(1), h(1). The value m(1) in turn reveals the difference between the number of 1's and the number of −1's in the randomly generated m, which will be a function of the original message under some encoding scheme. The question therefore arises as to how much information m(1) leaks. The expected value of m(1) is zero, but it becomes larger in absolute value as the disparity between the number of positive and negative 1's increases. As this disparity increases, the size of the search space for m decreases, making a so-called “meet in the middle” search for (r,m) easier. Thus, if adversaries could search through an arbitrarily long list of encrypted messages, they could concentrate their energies on a very small number of messages with sufficient large disparities to make such a search plausible. In fact, a list of messages must be exponentially long for such an attack to have a chance of succeeding. However, in the interest of ensuring the highest attainable level of security, it is among the objects hereof to eliminate the described possible attack on the cryptosystem by adversaries.

### SUMMARY OF THE INVENTION

In accordance with a feature hereof, a method is set forth for ensuring that, in the type of cryptosystem described, an encrypted message does not leak information by ensuring that for any encrypted message, i.e., ciphertext, e=(e₀, e₁, . . . , e_{N-1}), the sum e₀₊e₁+ . . . +e_{N-1} is constant. Note that after interpreting e as a polynomial: e=e₀+e₁x+e₂x²+ . . . +e_{N-1}x^{N-1}, this sum equals the polynomial evaluated at x=1. For an encrypted message of the form e=r·h+m, the technique hereof ensures that e(1) is constant by ensuring that r(1) and m(1) are constant. In an embodiment hereof, this is achieved as follows:

In place of the original encrypted message e=h·r+m, the encryptor reveals the altered encrypted message e=h·r+m−m(1). That is, the constant coefficient of the encrypted message has the value m(1) (mod q) subtracted from it. This effectively forces the value of the message, at an index of 1, to always equal 0, eliminating the attacker's ability to distinguish potentially weaker messages.

The process of decryption will proceed as before, the only difference being that every coefficient of the partially decrypted message f·e (mod q) will have 3m(1) subtracted from it. This will not alter the recovered message (except for the constant coefficient, which is discarded). It should be checked, however, that the possibility of decryption failure due to these larger coefficients remains acceptably low, for example less than 2⁻⁸⁰. For this purpose a maximum bound M is set. For example, if the absolute value of m(1) exceeds M the message can be re-encrypted. If it is less than or equal to M the message is accepted. In the Table of FIG. 5 there is provided, for each listed parameter set in the described cryptosystem, a number M for the maximal acceptable absolute value of m(1). Also provided is the probability that this bound is exceeded, using the symbol b to indicate that M is exceeded less often than 2^{-b} of the time.

[It can be noted that to protect against adaptive chosen ciphertext attacks, standardized versions of “NTRU Encrypt” require the decryptor to reconstruct the ciphertext from the plaintext and check that the reconstructed cipher text is equal to the received ciphertext (see, for example, N. Howgrave-Graham, J. H. Silverman, W Whyte, Choosing Parameter Sets for NTRUEncrypt with NAEP and SVES-3, Topics in Cryptology-CT-RSA 2005, 118-135, Lecture Notes in Comput. Sci., 3376, Springer, Berlin, 2005. Htt;:///www.ntru.com/cryptolab/articles. Htm#2005.1; IEEE Std 1363.1-2008, IEEE Standard Specification for Public Key Cryptographic Techniques Based on Hard Problems Over Lattices, 2008.) The modified encoding method hereof is consistent with the use of these protections and introduces no additional risks.]

The described technique need only be used when the number of ones and negative ones in f and r are very close to N/3, as it is only in this case that the attacker will find it easier to mount an attack on a thin m than to attack f or r.

As an example with k=112: The top row of Table 1 (see FIG. 5) describes the following protocol. To achieve 112 bit security, a private key polynomial is chosen to be of the form f=1+3F, where F is a polynomial chosen at random to have 134 coefficients set equal to 1, 134 coefficients set equal to −1, and the remainder set equal to zero. A second private key polynomial g is chosen to have 135 coefficients set equal to 1, 134 coefficients set equal to −1, and the remainder set equal to zero. A public key h is constructed by computing the polynomial 3g·f¹ modulo 2048. The message m will be a polynomial with M₁ coefficients equal to 1, M₂ coefficients equal to −1 and the remainder equal to 0. This can be obtained by appending a random padding to an original message m₀. An auxiliary polynomial r is constructed from m via a hash function, in such a way that the value r(1) is fixed and independent of m.

If |M₁−M₂|≦136 the message m is accepted and encrypted as e=h·r+m−M₁+M₂. If |M₁−M₂|>136 the message m is recomputed by adding a different random padding to m₀.

In a further embodiment, the ensuring that the value of e(1) is constant can be achieved as follows. Proceed is as in the prior case, except that when |M₁+M₂|≦M, the encrypted message is computed as e=h·(r−M₁+M₂)+m. As the protocol ensures that h(1)=1, this will accomplish the same goal as in the prior case. The same M from the Table 1 will work, and in fact M can be increased beyond the value in the Table by following this technique.

In accordance with a form of the invention, a method is set forth for encrypting and decrypting a message, including the following steps: selecting a plurality of integers and a plurality of vectors, and deriving therefrom a public key that includes a collection of vectors and a private key; selecting a message, in the form of a vector; selecting a vector of random weights; deriving a preliminary encrypted message, in the form of a vector, as a function of the selected message, the public key, and the random weights; evaluating the preliminary encrypted message to derive a normalizing value; combining the preliminary encrypted message and the normalizing value, to obtain a security-enhanced encrypted message; and decrypting the security-enhanced encrypted message using the private key, to recover the selected message. In an embodiment of this form of the invention, the step of selecting a vector of random weights comprises selecting a vector with one weight for each of the public key vectors. In this embodiment, the preliminary encrypted message eₚ is

eₚ=h*r+m (mod q)

where h is the collection of public key vectors, r is the collection of random weights, m is the selected message, and q is one of the selected plurality of integers; and wherein the security-enhanced message eₛₑ is

eₛₑ=h*r+m−m₁ (mod q)

where m₁ is the normalizing value. In this embodiment, the normalizing value, m₁, is obtained from a normalizing weight n, which is the sum, modulo q, of the elements of the selected message m, so that the normalizing value m₁ is chosen such that the sum of its indices is related to the normalizing weight n. Also in this embodiment, the normalizing value m₁ is obtained from the normalizing weight n by: selecting one or more indices; ensuring that the value of the selected message m at these indices is a known value; and generating m₁ such that m₁ is non-zero only at the selected indices, m₁ is 0 at all non-selected indices, and the sum of the entries of m₁ is n. A single index is selected and the value of m₁ at that index is set equal to m.

In an embodiment of this form of the invention, the step of decoding the security-enhanced encrypted message, using the private key, to recover the selected message, comprises: using the private key to recover the security-enhanced encrypted message; and deriving the selected message m from r*h+m+m₁. In this embodiment, the step of deriving the selected message m from r*h+m+m₁ is implemented by obtaining m+m₁ from r*h+m+m₁, obtaining the normalizing weight n from m+m₁, obtaining m₁ from n, and calculating m as (m+m₁)−m₁. The step of deriving the selected message m from r*h+m+m₁ can be implemented by: obtaining m+m₁ from r*h+m+m₁; selecting those indices corresponding to the non-zero values of m₁; and setting the entries of m+m₁ at those indices to 0. The step of selecting those indices corresponding to the non-zero values of m₁ is implemented by selecting a single index.

In a further form of the invention, a method is set forth for encrypting and decrypting a message, including the following steps: selecting a plurality of integers and a plurality of polynomials, and deriving therefrom a public key that includes a polynomial, and a private key; selecting a message, in the form of a polynomial; selecting a random polynomial; deriving a preliminary encrypted message, in the form of a polynomial, as a function of the selected message, the public key, and the random polynomial; evaluating the preliminary encrypted message to derive a normalizing value; combining the preliminary encrypted message and the normalizing value, to obtain a security-enhanced encrypted message; and decrypting the security-enhanced encrypted message using the private key, to recover the selected message. In an embodiment of this form of the invention, the preliminary encrypted message eₚ is

eₚ=h*r+m (mod q)

where h is the public key, r is the random polynomial, m is the selected message, and q is one of the selected plurality of integers; and the security-enhanced message eₛₑ is

eₛₑ=h*r+m−m₁ (mod q)

where m₁ is the normalizing value. In this embodiment, the normalizing value, m₁, is the value, modulo q, of the polynomial of the selected message, m, evaluated at x=1, where x is the polynomial variable. Also in this embodiment, the polynomial of the selected message is a polynomial whose coefficients lie between integers −k and +k, and said random polynomial is a polynomial whose coefficients consist of an equal number of +1's and −1's and the rest 0's.

Further features and advantages of the invention will become more readily apparent from the following detailed description when taken in conjunction with the accompanying drawings.

### BRIEF DESCRIPTION OF THE DRAWINGS

FIG. 1 is a block diagram of a system that can be used in practicing embodiments of the invention.

FIG. 2 is a flow diagram of a public key encryption system which, when taken with the subsidiary flow diagrams referred to therein, can be used in implementing embodiments of the invention.

FIG. 3 is a flow diagram in accordance with an embodiment of the invention, for encoding a message using a public key.

FIG. 4 is a flow diagram in accordance with an embodiment of the invention, for decoding an encoded message using a private key.

FIG. 5 is a Table that is useful in illustrating the operation and security level of an embodiment of the invention.

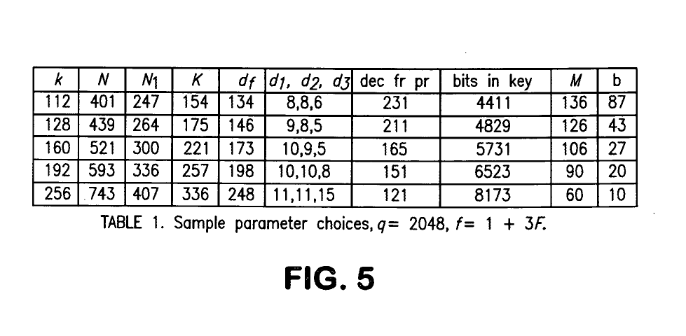

### DETAILED DESCRIPTION

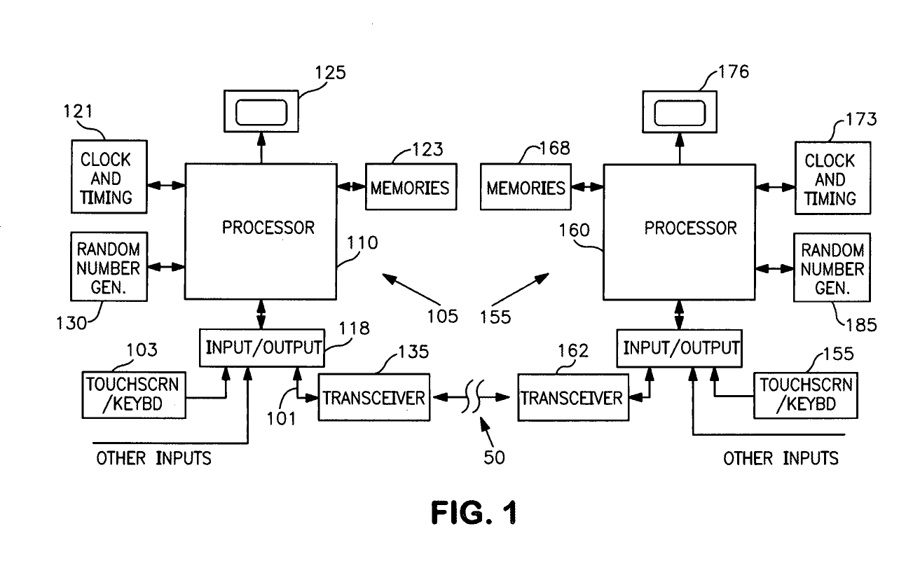

FIG. 1 is a block diagram of a system that can be used in practicing embodiments of the invention. Two processor-based subsystems 105 and 155 are shown as being in communication over an insecure channel 50, which may be, for example, any wired or wireless communication channel such as a telephone or internet communication channel. The subsystem 105 includes processor 110 and the subsystem 155 includes processor 160. The subsystems can typically comprise mobile devices, computers, or terminals. When programmed in the manner to be described, the processors 110 and 160 and their associated circuits can be used to implement an embodiment of the invention and to practice an embodiment of the method of the invention. The processors 110 and 160 may each be any suitable processor, for example an electronic digital processor or microprocessor. It will be understood that any general purpose or special purpose processor, or other machine or circuitry that can perform the functions described herein, electronically, optically, or by other means, can be utilized. As one example, the processors may be Intel “Core i7” processors. The subsystem 105 will typically include memories 123, clock and timing circuitry 121, input/output functions 118 and display 125, which may all be of conventional types. Inputs can include a touchscreen/keyboard input as represented at 103. Communication is via transceiver 135, which may comprise a modem or any suitable device for communicating signals.

The subsystem 155 in this illustrative embodiment can have a similar configuration to that of subsystem 105. The processor 160 has associated input/output circuitry 164, memories 168, clock and timing circuitry 173, and a display 176. Inputs include a touchscreen/keyboard 155. Communication of subsystem 155 with the outside world is via transceiver 162 which, again, may comprise a modem or any suitable device for communicating signals.

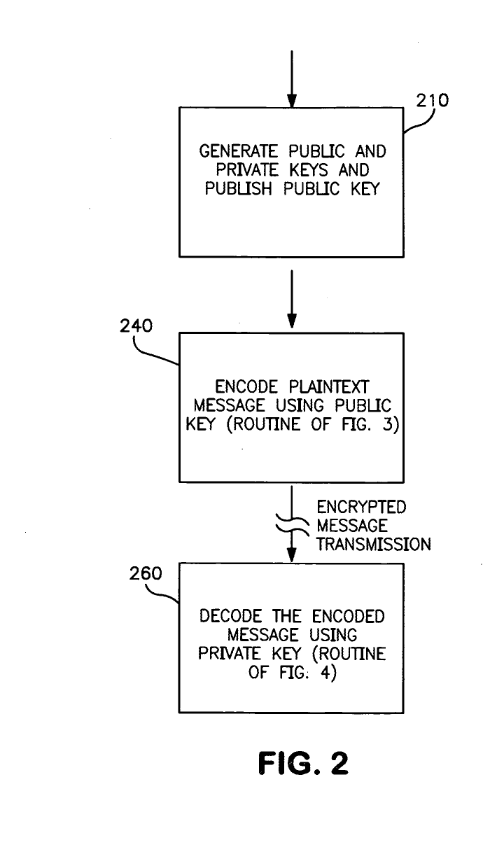

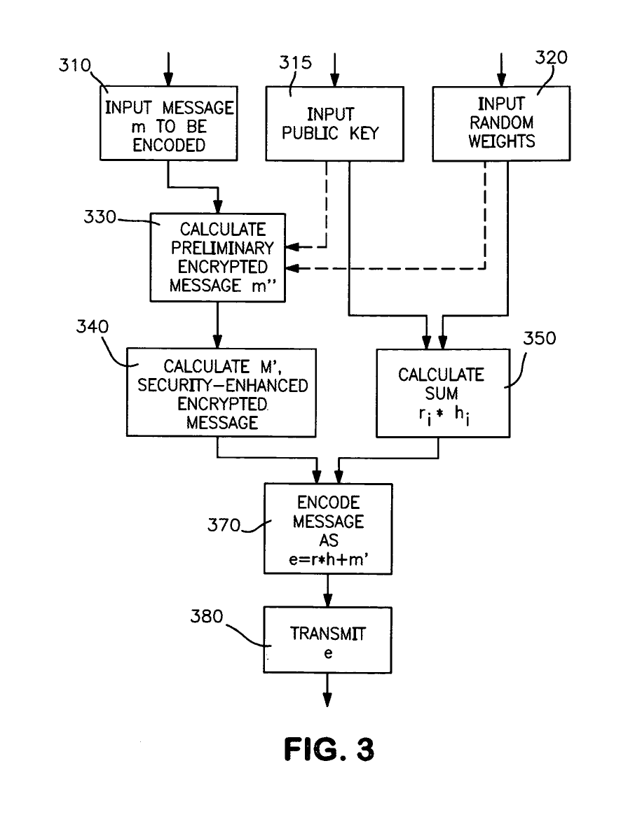

FIG. 2 illustrates a basic procedure that can be utilized with a public key encryption system, and refers to routines illustrated by other referenced flow diagrams which describe features in accordance with an embodiment of the invention. The block 210 represents the generating of the public key and private key information, and the “publishing” of the public key. The routine of an embodiment thereof is described, for example, in conjunction with the flow diagram of FIG. 3 of the above-referenced U.S. Pat. No. 6,081,597. In the present example, it can be assumed that this operation is performed at the processor system 105. The public key information can be published; that is, made available to any member of the public or to any desired group from whom the private key holder desires to receive encrypted messages. Typically, although not necessarily, the public key may be made available at a central public key library facility or website where a directory of public key holders and their public keys are maintained. In the present example, it is assumed that the user of the processor system 155 wants to send a confidential message to the user of processor system 105, and that the user of processor system 155 knows the published public key of the user of processor system 150. The public key, h, is a collection of M vectors of length N, and, as certain other vectors hereof, can alternatively be represented in the form of polynomials or matrices.

The block 240 represents the routine that can be used by the message sender (that is, in this example, the user of processor system 155) to encode a plaintext message using the public key of the intended message recipient. This routine, in accordance with an embodiment of the invention, is described in conjunction with the flow diagram of FIG. 3. The encrypted message is then transmitted over the channel 50 (FIG. 1).

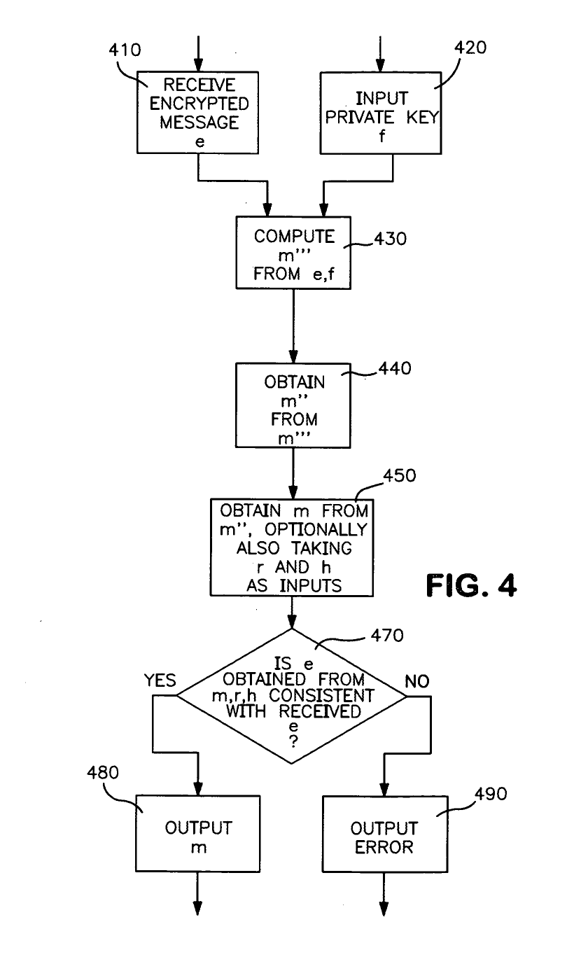

The block 260 of FIG. 2 represents the routine for the decoding of the encrypted message to recover the plaintext message. In the present example, this function is performed by the user of the processor system 105, who employs the private key information. The decoding routine, for an embodiment of the invention, is described in conjunction with the flow diagram of FIG. 4. The message m to be encrypted is input (block 310), as is the public key, h (block 315), and random weights, r (block 320). In this example, the message m to be encrypted is a vector of length N′<N. The public key is a collection of vectors of length N, each vector being denoted by hᵢ, i=1, 2, . . . M. The entire collection is denoted by h. For example, the set h may be generated by N rotations of an N-component vector, hᵢ. For the set of random weights, each individual weight is denoted by rᵢ, i=1, 2, . . . M, and the collection of weights is denoted by r. As represented by the block 330, the encrypter calculates a preliminary encrypted message m″. This calculation takes as input m and some randomness, and may additionally take as input the collections of vectors h and r. The resulting preliminary encrypted message is of length N′<N. From the preliminary encrypted message m″, the encrypter calculates the normalizing weight n and the security enhanced encrypted message m′ (block 340). m″ is a vector of length N such that N′ of the entries are equal to the N′ entries of m″, and the other (N−N′) entries are obtained by a formula such that the normalizing weight of those entries is equal to −n, n the normalizing weight. From the values input to blocks 315 and 320, the sum hᵢ·rᵢ is computed for all i (block 350). Then, the encoded message, e, is computed (block 370) as e=sum_i(hᵢrᵢ)+m′(modq), and is transmitted (block 380).

FIG. 4 is a flow diagram in accordance with an embodiment of the invention, for decoding an encoded message using a private key. The block 410 represents the inputting of the received encoded message, e, and the block 420 represents the inputting of the private key, f. Then, as represented by the block 430, the private key, f, is used to obtain, from the encoded message e, the decrypted security-enhanced message, m′″. The derived m′″ is a vector of length N such that N′ of the entries are equal to the N′ entries of m″. (As was described above [in conjunction with block 340], m″ was the calculated preliminary encrypted message.) This process may also, optionally, output the random weights, r. Then, as represented by the block 440, the preliminary encrypted message m″ is obtained from m′″, by selecting the appropriate N′ entries. Next, the original message m is obtained from m″ (block 450) by the inverse of the process described in conjunction with the block 330 of the encryption process. This can optionally involve the random weights, r (as obtained in conjunction with block 430) and h (known from the encrypter's public key). Determination can then be made (decision block 470) as to whether a reconstructed encoded message, e, obtained from m, r, and h, is consistent with the received encoded message e. If so, the message m can be safely output (block 480). If not, an error indication is output (block 490).

The invention has been described with reference to particular preferred embodiments, but variations within the spirit and scope of the invention will occur to those skilled in the art. For example, it will be understood that alternative techniques can be employed for determining the security-enhanced encrypted message, consistent with the principles hereof.

1. A method for encrypting and decrypting a message, comprising the steps of:
selecting a plurality of integers and a plurality of vectors, and deriving therefrom a public key that includes a collection of vectors and a private key;
selecting a message, in the form of a vector;
selecting a vector of random weights;
deriving a preliminary encrypted message, in the form of a vector, as a function of the selected message, the public key, and the random weights;
evaluating the preliminary encrypted message to derive a normalizing value;
combining the preliminary encrypted message and the normalizing value, to obtain a security-enhanced encrypted message; and
decrypting the security-enhanced encrypted message using the private key, to recover the selected message.

2. The method as defined by claim 1, wherein said step of selecting a vector of random weights comprises selecting a vector with one weight for each of the public key vectors.

3. The method as defined by claim 1, wherein the preliminary encrypted message eₚ is
eₚ=h*r+m (mod q)
where h is the collection of public key vectors, r is the collection of random weights, m is the selected message, and q is one of the selected plurality of integers; and wherein the security-enhanced message eₛₑ is
eₛₑ=h*r+m−m₁ (mod q)
where m₁ is the normalizing value.

4. The method as defined by claim 3, wherein the normalizing value, m₁, is obtained from a normalizing weight n, which is the sum, modulo q, of the elements of the selected message m, so that the normalizing value m₁ is chosen such that the sum of its indices is related to the normalizing weight n.

5. The method as defined by claim 4, wherein the normalizing value m₁ is obtained from the normalizing weight n by: selecting one or more indices; ensuring that the value of the selected message m at these indices is a known value; and generating m₁ such that m₁ is non-zero only at the selected indices, m₁ is 0 at all non-selected indices, and the sum of the entries of m₁ is n.

6. The method as defined by claim 5, wherein a single index is selected and the value of m₁ at that index is set equal to m.

7. The method as defined by claim 1, wherein said step of decoding the security-enhanced encrypted message, using the private key, to recover the selected message, comprises: using the private key to recover the security-enhanced encrypted message; and deriving the selected message m from r*h+m+m₁.

8. The method as defined by claim 7, wherein said step of deriving the selected message m from r*h+m+m₁ is implemented by obtaining m+m₁ from r*h+m+m₁, obtaining the normalizing weight n from m+m₁, obtaining m₁ from n, and calculating m as (m+m₁)−m₁.

9. The method as defined by claim 7, wherein said step of deriving the selected message m from r*h+m+m₁ is implemented by: obtaining m+m₁ from r*h+m+m₁;
selecting those indices corresponding to the non-zero values of m₁; and setting the entries of m+m₁ at those indices to 0.

10. The method as defined by claim 9, wherein said step of selecting those indices corresponding to the non-zero values of m₁ is implemented by selecting a single index.

11. The method as defined by claim 1, wherein the steps of said method are implemented using at least one processor-based subsystem.

12. The method as defined by claim 1, wherein the encrypting is performed using a first processor-based subsystem, and the decrypting is performed using a second processor-based subsystem.

13. The method as defined by claim 1, wherein the security-enhanced encrypted message is produced by a user at one location, transmitted from said one location to another location, and decrypted by a user at said another location.

14. The method as defined by claim 1, wherein the security-enhanced encrypted message is produced by a user at one location using a first processor-based subsystem, transmitted from said one location to another location, and decrypted by a user at said another location using a second processor-based subsystem.

15. A method for encrypting and decrypting a message, comprising the steps of:
selecting a plurality of integers and a plurality of polynomials, and deriving therefrom a public key that includes a polynomial, and a private key;
selecting a message, in the form of a polynomial;
selecting a random polynomial;
deriving a preliminary encrypted message, in the form of a polynomial, as a function of the selected message, the public key, and the random polynomial;
evaluating the preliminary encrypted message to derive a normalizing value;
combining the preliminary encrypted message and the normalizing value, to obtain a security-enhanced encrypted message; and
decrypting the security-enhanced encrypted message using the private key, to recover the selected message.

16. The method as defined by claim 15, wherein the preliminary encrypted message eₚ is
eₚ=h*r+m (mod q)
where h is the public key, r is the random polynomial, m is the selected message, and q is one of the selected plurality of integers; and wherein the security-enhanced message eₛₑ is
eₛₑ=h*r+m−m₁ (mod q)
where m₁ is the normalizing value.

17. The method as defined by claim 16, wherein the normalizing value, m₁, is the value, modulo q, of the polynomial of the selected message, m, evaluated at x=1, where x is the polynomial variable.

18. The method as defined by claim 15, wherein the polynomial of the selected message is a polynomial whose coefficients lie between integers −k and +k, and said random polynomial is a polynomial whose coefficients consist of an equal number of +1's and −1's and the rest 0's.

19. The method as defined by claim 15, wherein the steps of said method are implemented using at least one processor-based subsystem.

20. The method as defined by claim 15, wherein the encrypting is performed using a first processor-based subsystem, and the decrypting is performed using a second processor-based subsystem.

21. The method as defined by claim 15, wherein the security-enhanced encrypted message is produced by a user at one location, transmitted from said one location to another location, and decrypted by a user at said another location.

22. The method as defined by claim 15, wherein the security-enhanced encrypted message is produced by a user at one location using a first processor-based subsystem, transmitted from said one location to another location, and decrypted by a user at said another location using a second processor-based subsystem.

23. For use in conjunction with a public key cryptosystem that uses a public key and a private key obtained by selecting a plurality of integers and a plurality of polynomials and deriving therefrom a public key that includes a polynomial and a private key, a method for encrypting a message with enhanced security, comprising the steps of:
selecting a message, in the form of a polynomial;
selecting a random polynomial;
deriving a preliminary encrypted message, in the form of a polynomial, as a function of the selected message and the random polynomial:
evaluating the preliminary encrypted message to derive a normalizing value; and
combining the preliminary encrypted message and the normalizing value, to obtain a security-enhanced encrypted message.

24. The method as defined by claim 23, wherein the preliminary encrypted message eₚ is
eₚ=h*r+m (mod q)
where h is the public key, r is the random polynomial, m is the selected message, and q is one of the selected plurality of integers; and wherein the security-enhanced message eₛₑ is
eₛₑ=h*r+m−m₁ (mod q)
where m₁ is the normalizing value.

25. The method as defined by claim 24, wherein the normalizing value, m₁, is the value, modulo q, of the polynomial of the selected message, m, evaluated at x=1, where x is the polynomial variable.
